(19) United States
(12) Patent Application Publication
(10) Pub. No.: US 2020/0326600 A1
(43) Pub. Date: Oct. 15, 2020

(54) LIQUID CRYSTAL DISPLAY DEVICE

(71) Applicant: Sakai Display Products Corporation, Osaka (JP)

(72) Inventors: Yukio YOSHIDA, Sakai-shi (JP); Nobuo OKANO, Sakai-shi (JP)

(73) Assignee: Sakai Display Products Corporation, Osaka (JP)

(21) Appl. No.: 15/779,211

(22) PCT Filed: Nov. 27, 2015
(86) PCT No.: PCT/JP2015/083489

§ 371 Date: Jul. 24, 2018

(51) Int. Cl. G02F 1/1362; G02F 1/1368

(52) U.S. Cl. CPC G02F 1/136209; G02F 1/1368

(57) ABSTRACT

Provided is a liquid crystal display device in which: bias is mitigated in the event that bias has occurred in the liquid crystal material of a liquid crystal layer; variations in the cell thickness do not occur; and display irregularities are controlled. A display crystal panel 1 is equipped with: a TFT substrate 2 and an opposing substrate 3 which are rectangular in shape and adhered together by a seal material 4 formed at the inner peripheral side; a liquid crystal layer 5 provided on the inner peripheral side of the seal material between the two substrates; a rectangular rim-shaped frame BM 32 provided on the liquid crystal layer 5 side of the opposing substrate 3; and a linear recessed portion 33 provided in at least a circumferential-direction section of the frame BM 32.

### TECHNICAL FIELD

The present invention relates to a liquid crystal display apparatus with a thin film transistor (TFT) substrate provided for example in a television receiver or a personal computer.

### BACKGROUND ART

Among display apparatuses, liquid crystal display apparatuses are thin and consume less power. In particular, a liquid crystal display apparatus including a TFT (i.e., thin film transistor or active matrix) substrate with switching elements such as TFTs for respective pixels, which has a high contrast ratio and exhibits excellent responsiveness and high performance, is favorably used for example in television receivers and personal computers.

A television receiver (also referred to below as a TV receiver) including a liquid crystal display apparatus includes for example a display panel, a display module, a front cabinet, and a rear cabinet. The display panel displays a picture on a front side thereof. The display module includes a backlight unit that irradiates a back side of the display panel with light. The front cabinet covers a side surface and a peripheral part of a front surface of the display module. The rear cabinet covers a back surface of the display module.

The display panel includes a TFT substrate, a counter substrate (color filter substrate), a liquid crystal layer, a sealant, and two polarizing plates. The TFT substrate and the counter substrate are opposite to each other. The liquid crystal layer is provided as a display medium layer between the TFT substrate and the counter substrate. The sealant seals the TFT substrate and the counter substrate together and has a frame shape in which the liquid crystal layer is sealed in between the TFT substrate and the counter substrate. The respective polarizing plates are disposed on respective outer surfaces of the TFT substrate and the counter substrate.

In a situation in which one of the polarizing plates is attached to a bonded substrate in which the counter substrate and the TFT substrate are bonded together, the polarizing plate is placed on an outer surface of the bonded substrate and a polarizing plate attaching roller is rolled and moved on the polarizing plate while in a pressing state for attachment. Alternatively, the bonded substrate and the polarizing plate may be attached to each other into a curved shape in a manner that: the polarizing plate is held by suction on an upper surface of an upwardly convex stage; the bonded substrate is placed on one end of the upper surface of the polarizing plate; and a roller is pressed toward the stage to bond the bonded substrate to the polarizing plate.

In attachment of the polarizing plate to the bonded substrate, the bonded substrate is pressed by the polarizing plate attaching roller and receives pressure to push and move a liquid crystal material toward an end of the liquid crystal layer where attachment of the polarizing plate terminates. This may gather the liquid crystal material locally in a part of a cell located on a side where attachment terminates.

In particular, a display panel having a thin glass substrate has a strong tendency to cause local gathering of the liquid crystal material in attachment of the polarizing plate.

Local gathering of the liquid crystal material caused in the cell may cause variation in cell thickness to cause display irregularity.

Patent Literature 1 discloses a liquid crystal display apparatus in which a protrusion having a height H and a width W1 is provided on a surface of the counter substrate which faces the liquid crystal layer while a recess having a depth D larger than the height H and a width W2 smaller by one spacer to be disposed therein than the width W1 is formed in a region of in a surface of the TFT substrate which faces the liquid crystal layer in correspondence with the protrusion. In the above liquid crystal display apparatus, spacers on the protrusion are located in a region of the recess and another region. Among the spacers, the spacers located in the other region define the cell thickness and support the protrusion. Further, the presence of the spacer in the recess prevents an increase in cell thickness by the thickness of the protrusion.

### CITATION LIST

### Patent Literature

### [Patent Literature 1]

Japanese Patent No. 3962196

### SUMMARY OF INVENTION

### Technical Problem

The protrusion and the recess of the liquid crystal display according to Patent Literature 1 as described above are located along the periphery of a frame region. However, it is not considered that a problem in attachment of the polarizing plate to the bonded substrate that the liquid crystal material is pushed and moved toward a part of the liquid crystal where attachment of the polarizing plate terminates to locally gather the liquid crystal material at the part thereof where attachment terminates in the cell, as described above, is solved by releasing the local gathering of the liquid crystal material in a manner to move the liquid crystal material in a direction toward a part where intra-cell pressure is low and opposite to a direction in which the polarizing plate attaching roller moves.

The present invention has been made in view of the aforementioned problem and has its object of providing a liquid crystal display apparatus in which local gathering of the liquid crystal material in the liquid crystal layer is released and occurrence of display irregularity is prevented without variation in cell thickness.

### Solution to Problem

A liquid crystal display apparatus according to one embodiment of the present invention includes two substrates, a liquid crystal layer, a shielding film, and a recess. The two substrates each have a rectangular shape and are bonded to each other with a sealant around inward peripheries of the respective substrates. The liquid crystal layer is located inward of the sealant between the substrates. The light shielding film has a rectangular frame shape and is disposed on a surface of one substrate of the two substrates. The surface faces the liquid crystal layer. The recess is in a linear shape extending in at least a part of a periphery of the light shielding film.

In the embodiment of the present invention, when a liquid crystal material in the liquid crystal layer locally gathers for example in attachment of one of the substrates to a polarizing plate, the liquid crystal material flows into the recess and moves to another prat of the liquid crystal layer. Thus, local gathering of the liquid crystal material can be released. As a result, occurrence of display irregularity caused due to variation in cell thickness can be prevented.

In the liquid crystal display apparatus according to the embodiment of the present invention, the recess includes a portion located at at least a part of a short side of the light shielding film and a portion located at at least a part of a long side of the light shielding film. The long side of the light shielding film is connected to the short side thereof with a corner therebetween.

In the embodiment of the present invention, when the liquid crystal material locally gathers at a part of the liquid crystal layer where attachment terminates, that is, a part of the substrate corresponding to the short side of the light shielding film in attachment of a polarizing plate to the substrate by rolling a polarizing plate attaching roller for example in a longitudinal direction of the substrate, the liquid crystal material can flow from the short side toward the long side of the recess and move in a direction opposite to a direction in which the polarizing plate attaching roller moves, that is, move to a part of the liquid crystal layer located opposite to the part where the liquid crystal material locally gathers. Even in a situation in which the liquid crystal material locally gathers at a part of the liquid crystal layer corresponding to the long side of the recess, the liquid crystal material can flow from the long side into the short side of the recess and move toward a prat of the liquid crystal layer located opposite to the part where the liquid crystal material locally gathers. Thus, gathering of the liquid crystal material can be released.

In the liquid crystal display apparatus according to the embodiment of the present invention, the recess may extend around an entire periphery of the light shielding film.

In the embodiment of the present invention, even when the liquid crystal material locally gathers in attachment of the polarizing plate, the liquid crystal material can favorably flow toward a part of the liquid crystal layer located opposite to the part thereof where the liquid crystal material locally gathers, that is, toward a part thereof where attachment starts.

The liquid crystal display apparatus according to the embodiment of the present invention further includes a second recess may extend to be connected to the recess in plan view of the substrates and the liquid crystal layer in a pixel region.

In the embodiment of the present invention, the liquid crystal material can flow into a middle part between the part of the liquid crystal layer where the liquid crystal material locally gathers and the part thereof located opposite to the part where the liquid crystal material locally gathers, with a result that the cell thickness can be further evened out. Furthermore, in a configuration in which the second recess is connected to an end of the recess, the liquid crystal material can readily flows from the liquid crystal layer toward the recess or from the recess toward the liquid crystal layer.

In the liquid crystal display apparatus according to the embodiment of the present invention, the one of the substrates may be a counter substrate including a counter electrode and the shielding film may be a black matrix provided on the counter substrate in a frame region.

In the embodiment of the present invention, the recess extends in the frame black matrix of the counter substrate. That is, the recess extends in a part of the counter substrate where attachment of the polarizing plate to the substrate terminates and where the liquid crystal material tends to gather. In the above configuration, local gathering of the liquid crystal material can be favorably released.

In the liquid crystal display apparatus according to the embodiment of the present invention, the one of the substrate may be a thin film transistor substrate and the light shielding film may be a black matrix provided on the thin film transistor substrate in a frame region.

In the embodiment of the present invention, the recess extends in a frame black matrix on the thin film transistor substrate. That is, the recess extends in a part of the thin film transistor substrate where attachment of the polarizing plate to the substrate terminates and where the liquid crystal material tends to gather. In the above configuration, local gathering of the liquid crystal material can be favorably released.

### Advantageous Effects of Invention

According to the embodiment of the present invention, a linear recess extends in at least a periphery of the rectangular frame-shaped light shielding film provided on a surface of one of the substrates that faces the liquid crystal layer. In the above configuration, when the liquid crystal material of the liquid crystal layer locally gathers for example in attachment of the polarizing plate to the substrate, the liquid crystal material flows in the recess toward another part of the liquid crystal layer to release local gathering of the liquid crystal material. Thus, occurrence of display irregularity caused due to variation in cell thickness can be prevented.

### BRIEF DESCRIPTION OF DRAWINGS

FIG. 1 is a schematic perspective view illustrating a TV receiver according to a first embodiment.

FIG. 2 is a schematic cross sectional view of a display panel when viewed in a longitudinal direction thereof.

FIG. 3 is a schematic plan view illustrating a bonded substrate in which a counter substrate and a TFT substrate are bonded together before a polarizing plate is attached.

FIG. 4 is a schematic plan view illustrating a state of the polarizing plate being attached onto an insulating substrate.

FIG. 5 is a schematic cross sectional view illustrating a configuration in which a frame BM has no recess.

FIG. 6 is a schematic plan view illustrating a state of the polarizing plate being attached onto the insulating substrate in a configuration in which the frame BM has no recess.

FIG. 7 is a schematic cross sectional view illustrating a display panel according to a second embodiment.

FIG. 8 is a schematic plan view illustrating the bonded substrate in which the counter substrate and the TFT substrate are bonded together before the polarizing plate is attached.

FIG. 9 is a schematic plan view illustrating the bonded substrate in which the counter substrate and the TFT substrate are bonded together according to a third embodiment.

FIG. 10 is a schematic plan view illustrating the bonded substrate in which the counter substrate and the TFT substrate are bonded together according to a fourth embodiment.

FIG. 11 is a schematic cross sectional view of a display panel according to a fifth embodiment as viewed in a longitudinal direction thereof.

FIG. 12 is a schematic cross sectional view of a display panel according to a sixth embodiment as viewed in a longitudinal direction thereof.

### DESCRIPTION OF EMBODIMENTS

The following describes embodiments of the present invention in detail with reference to drawings illustrating embodiments thereof.

### First Embodiment

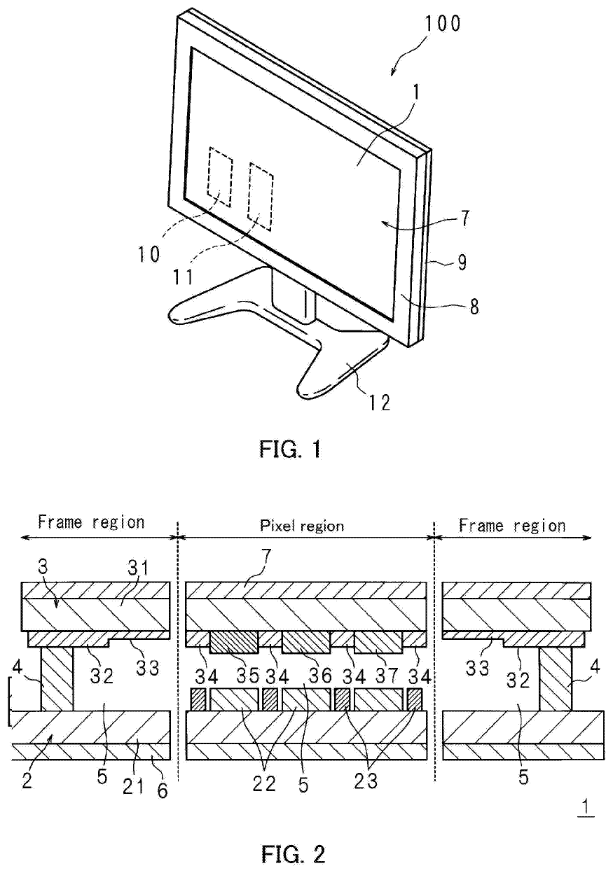

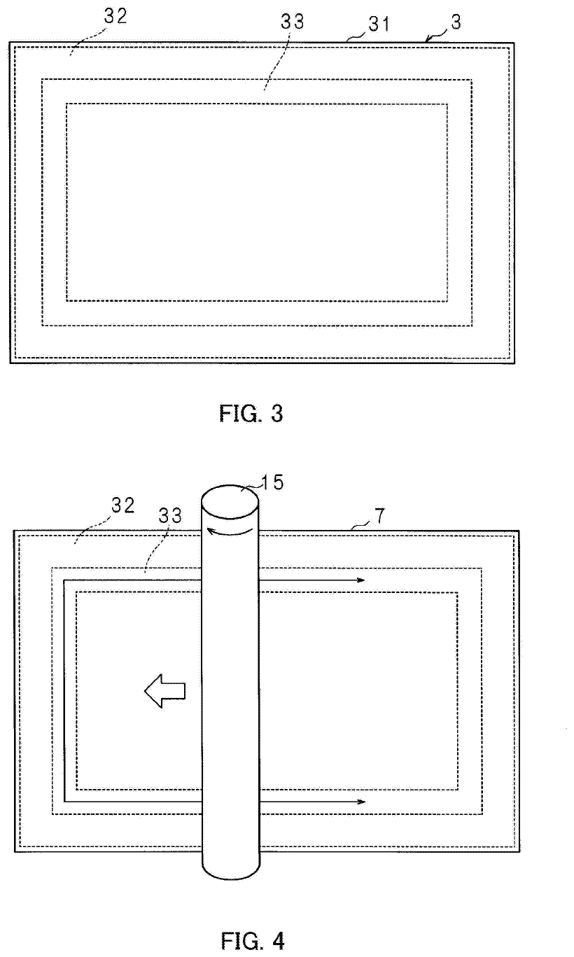

FIG. 1 is a schematic perspective view illustrating a TV receiver 100 according to the first embodiment. FIG. 2 is a schematic cross sectional view of a display panel 1 as viewed in a longitudinal direction thereof. FIG. 3 is a schematic plan view illustrating a bonded substrate in which a counter substrate 3 and a TFT substrate 2 are bonded together before a polarizing plate 7 is attached.

The TV receiver 100 includes a transversely oblong display module 17, an aluminum front cabinet 8, a synthetic resin-made rear cabinet 9, a tuner 10, a decoder 11 and a stand 12. The display module 17 includes the display panel 1 that displays a picture. The front cabinet 8 and the rear cabinet 9 sandwich and accommodate the display module 17 therebetween. The tuner 10 receives broadcast waves from an antenna (not illustrated). The decoder 11 decodes encoded broadcast waves. The display module 17, which has a substantially transversely rectangular parallelepipedal shape as a whole, is accommodated and stands between the front cabinet 8 and the rear cabinet 9.

In a configuration in which the display module 17 is for example of edge light type, the display module 17 includes the display panel 1, a light guide plate (not illustrated), an LED substrate (not illustrated), a reflection sheet (not illustrated), a chassis (not illustrated), and for example three optical sheets (not illustrated).

As illustrated in FIG. 2, the display panel 1 includes a TFT substrate 2, a counter substrate 3, a liquid crystal layer 5, a frame-shaped sealant 4, and polarizing plates 6 and 7. The TFT substrate 2 and the counter substrate 3 are opposite to each other. The liquid crystal layer 5 is disposed between the TFT substrate 2 and the counter substrate 3 as a display medium layer. The sealant 4 bonds the TFT substrate 2 and the counter substrate 3 together and seals the liquid crystal layer 5 in between the TFT substrate 2 and the counter substrate 3. The polarizing plates 6 and 7 are disposed on respective outer surfaces of the TFT substrate 2 and the counter substrate 3.

The TFT substrate 2 has a plane area larger than that of the counter substrate 3.

Note that a distance between the TFT substrate 2 and the counter substrate 3 opposite to each other (thickness of the liquid crystal layer 5) is kept fixed for example by a columnar spacer (not illustrated) provided at either of the TFT substrate 2 and the counter substrate 3 that face each other. The same is applied to the other embodiments described later.

A pixel region displays a picture or an image, and refers to a region in which the TFT substrate 2, the liquid crystal layer 5, and the counter substrate 3 are superposed in plan view. The outer periphery of pixel region is located slightly inward of a frame region where the sealant 4 is located.

As illustrated in FIG. 2, the TFT substrate 2 includes a plurality of signal lines (source lines) 23, a plurality of gate lines (not illustrated), a plurality of TFTs (not illustrated), a plurality of pixel electrodes 22, and an alignment film (not illustrated) on an insulating substrate 21 of for example a glass substrate in the pixel region. The signal lines are arranged in parallel in a row direction. The gate lines are arranged in parallel in a direction across the signal lines 23, that is, a column direction. The TFTs are provided at respective intersections of the signal lines 23 and the gate lines, that is, for respective pixels. The pixel electrodes 22 are arranged in matrix and connected to the respective TFTs. The alignment film covers the pixel electrodes 22.

The counter substrate 3 includes red CFs 35, green CFs 36, blue CFs 37 each formed on an insulating substrate 31 such as a glass substrate, a lattice-shaped pixel black matrix (also referred to below as a pixel BM) 34 that defines each of the CFs, a rectangular frame-shaped frame black matrix (also referred to below as a frame BM) 32 located in the frame region, a counter electrode (not illustrated) covering the CFs and the pixel BM 34, and an alignment film (not illustrated) covering the counter electrode. The frame BM 32, the pixel BM 34, the red CFs 35, the green CFs 36, and the blue CFs 37 each are made of for example a photosensitive resin and respectively colored in black, black, red, green, and blue with respectively corresponding color pigments. The red CFs 35, the green CFs 36, and the blue CFs 37 each may have a thickness larger than the frame BM 32 and the pixel BM 34.

The red CFs 35, the green CFs 36, and the blue CFs 37 are each provided for a corresponding one of the pixel electrodes 22. Pixels are each composed of a set of a red CF 35, a green CF 36, and a blue CF 37. Only one pixel is illustrated in the pixel region in FIG. 2. The pixels are arranged in matrix in the row direction and the column direction.

Provision of the frame BM 32 and the pixel BM 34 can prevent light leakage in black color display, color mixing of adjacent CFs, and generation of photocurrent by light irradiation to the TFTs.

The sealant 4 bonds the insulating substrate 21 and a periphery of the frame BM 32 together.

A notched recess 33 is formed in a stepwise manner in a part of the frame BM 32 located inwardly near the pixel region of the liquid crystal layer 5.

As illustrated in FIG. 3, the recess 33 has a rectangular frame shape extending around the entire periphery of the frame BM 32. The inner end of the frame BM 32 and the outer end of the pixel BM 34 are connected to each other along a boundary between the frame region and the pixel region. Accordingly, the recess 33 has a recessed groove shape.

FIG. 4 is a schematic plan view illustrating a state of the polarizing plate 7 being attached to the insulating substrate 31. The polarizing plate 7 is attached to the insulating substrate 31 in a manner that the polarizing plate 7 is placed on an outer surface of the insulating substrate 31 and a polarizing plate attaching roller 15 is rolled and moved leftward from the right in FIG. 4 while in a pressing state.

Note that the bonded substrate and the polarizing plate 7 may be attached to each other into a curved shape in a manner that the polarizing plate 7 is sucked and held on an upwardly or downwardly curved stage (not illustrated), the bonded substrate is placed on one of ends of the polarizing plate 7, and a polarizing plate attaching roller is pressed against the stage to bond the bonded substrate to the polarizing plate 7.

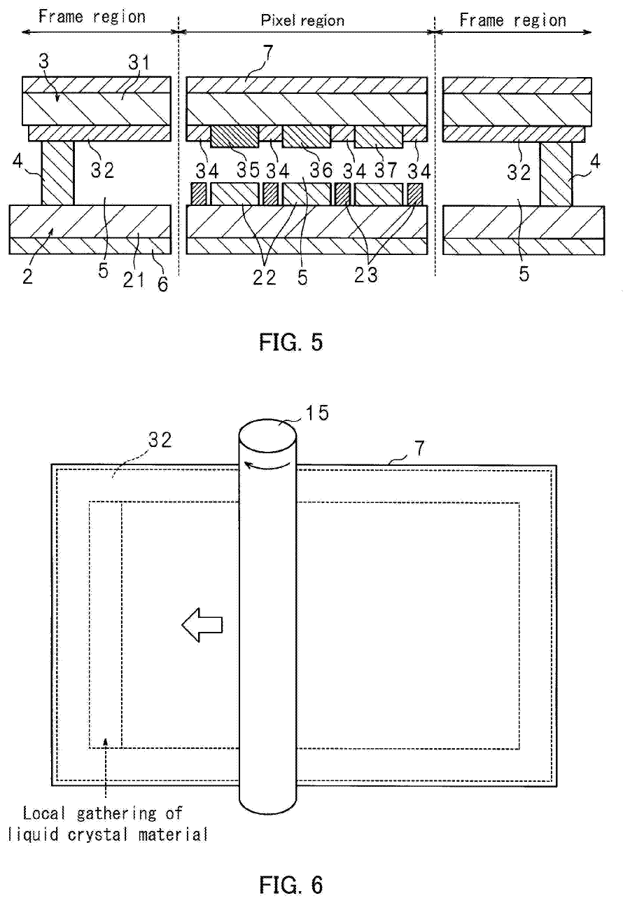

FIG. 5 is a schematic cross sectional view illustrating a configuration in which the frame BM 32 has no recess 33. FIG. 6 is a schematic plan view illustrating a state of the polarizing plate 7 being attached onto the insulating substrate 31 in a configuration in which the frame BM 32 has no recess 33. Elements in FIGS. 5 and 6 that are the same as those in FIGS. 2 and 4 are labelled using the same reference signs, and detailed description thereof is omitted.

In a configuration in which no recess 33 is formed in the frame BM 32 as illustrated in FIG. 6, when the polarizing plate attaching roller 15 is rolled on the polarizing plate 7, the liquid crystal layer 5 is pressed by the polarizing plate attaching roller 15 and receives pressure, so that a liquid crystal material is pushed and moved toward a part of the liquid crystal layer 5 where attachment of the polarizing plate 7 terminates (left short side of the liquid crystal layer 5) with a result that the liquid crystal material locally gathers.

When the polarizing plate attaching roller 15 is rolled on the polarizing plate 7, as illustrated in FIG. 4, and internal pressure of the liquid crystal layer 5 increases by local gathering of the liquid crystal material at a part of the liquid crystal layer 5 where attachment of the polarizing plate 7 terminates, the liquid crystal material flows into the recess 33 as indicated by arrows in the drawing and moves toward a part of the liquid crystal layer 5 located opposite to a part thereof where attachment terminates in the present embodiment. Thus, local gathering of the liquid crystal material can be released. As a result, occurrence of display irregularity caused due to variation in cell thickness can be prevented.

In the present embodiment, the recess 33 extends in the frame BM 32 of the counter substrate 3. This means that the recess is formed in a part of the frame BM 32 corresponding to a part of the liquid crystal layer 5 where attachment of the polarizing plate 7 to the insulating substrate 31 terminates and where the liquid crystal material tends to gather locally. Therefore, local gathering of the liquid crystal material can be favorably released.

Note that the recess 33 is formed into a recessed groove shape through an end of the frame BM 32 being connected to an end of the BM 34 in the pixel region. However, the present embodiment is not intended to be limited to a configuration in which the recess 33 is formed into a recessed groove shape through connection therebetween. The recess 33 may be open inward. However, the recess 33 having a recessed groove shape is preferable because the liquid crystal material can extensively flow in the recess 33 to further even out the liquid crystal layer 5.

Description has been made about a case where the polarizing plate 7 is attached to the insulating substrate 31 in the present embodiment. However, even when the liquid crystal material locally gathers by being pushed and moved toward a part of the liquid crystal layer 5 where attachment of the polarizing plate 6 terminates in a situation in which the polarizing plate attaching roller 15 is rolled on the polarizing plate 6 with the polarizing plate 6 aligned with the insulating substrate 21, the liquid crystal material can flow in the recess 33 toward a part of the liquid crystal layer 5 located opposite to a part thereof where attachment terminates. Thus, local gathering of the liquid crystal material can be released in a like manner.

The polarizing plate attaching roller 15 is not limited to being rolled in a longitudinal direction of the bonded substrate. Even in a situation in which the liquid crystal material locally gathers at a long side of the liquid crystal layer 5 by rolling the polarizing plate attaching roller 15 in a short direction of the bonded substrate, local gathering of the liquid crystal material can be released in a like manner.

### Second Embodiment

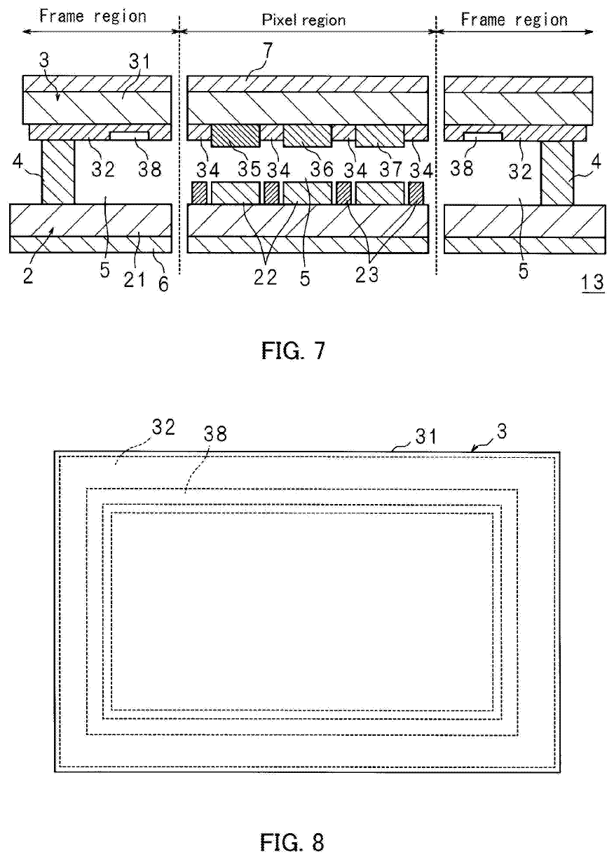

FIG. 7 is a schematic cross sectional view illustrating a display panel 13 according to a second embodiment. FIG. 8 is a schematic plan view illustrating the bonded substrate in which the counter substrate 3 and the TFT substrate 2 are bonded together before the polarizing plate 7 is attached. Elements in FIGS. 7 and 8 that are the same as those in FIGS. 2 and 3 are labelled using the same reference signs, and detailed description thereof is omitted.

In the display panel 13, a recess 38 in a recessed groove shape extends around the entire periphery of the frame BM 32 in a part of the frame BM 32 located inwardly near the pixel region of the liquid crystal layer 5.

In also the display panel 13 in the second embodiment, when internal pressure of the liquid crystal layer 5 increases by local gathering of the liquid crystal material at a part of the liquid crystal layer 5 where attachment of the polarizing plate 7 terminates, similarly to in the display panel 1, in a situation in which the polarizing plate 7 is attached onto the insulating substrate 31 by rolling the polarizing plate attaching roller 15, the liquid crystal material flows into the recess 38 and moves toward a part of the liquid crystal layer 5 located opposite to a part thereof where attachment terminates. Thus, local gathering of the liquid crystal material can be released.

The recess 33 in the display panel 1 is connected to the end of the pixel BM 34. In the above configuration, the recess 33 is connected the end thereof to be formed into a recessed groove shape. By contrast, a recessed groove is formed in the frame BM 32 in the display panel 13. Therefore, the recess 38 may not be connected to the end of the pixel BM 32. Therefore, the liquid crystal material can flow without hindrance of any other elements having any shapes.

### Third Embodiment

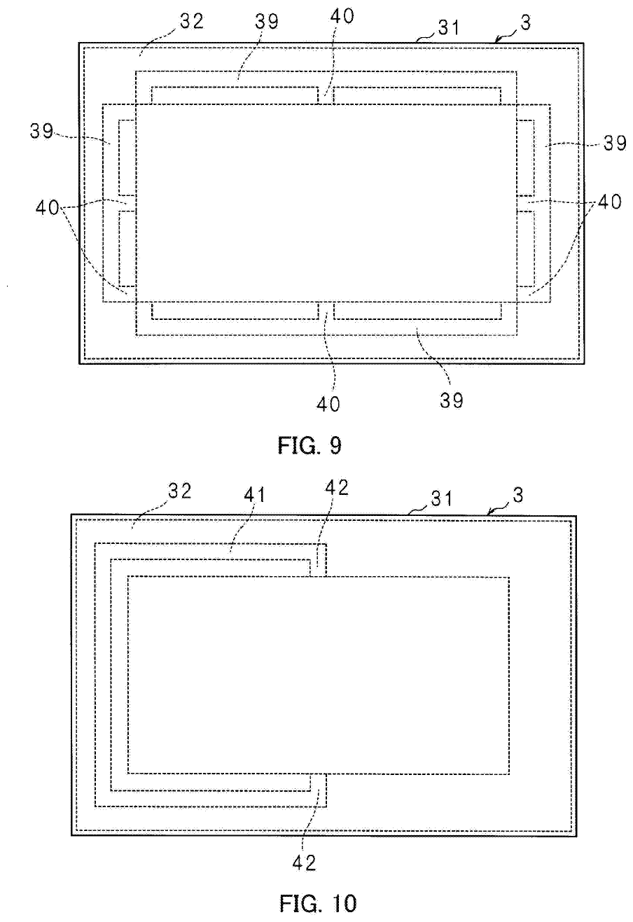

FIG. 9 is a schematic plan view illustrating the bonded substrate in which the counter substrate 3 and the TFT substrate 2 are bonded together according to a third embodiment. Elements in the drawing that are the same as those in FIG. 8 are labelled using the same reference signs, and detailed description thereof is omitted.

In the third embodiment, a plurality of first recesses 39 and a plurality of second recesses 40 extend in short sides and long sides of the frame BM 32. The first recesses 39 extend along the periphery of the frame BM 32. The second recesses 40 each extend continuously and perpendicularly to a corresponding one of opposite ends and central parts of the first recesses 39 in plan view of the insulating substrate 31 and communicate with the liquid crystal layer 5 in the pixel region.

In the present embodiment, flow paths of the liquid crystal material branch to the second recesses 40. In the above configuration, when the liquid crystal material locally gathers at a part of the liquid crystal layer 5 where attachment of the polarizing plate 7 terminates in attachment of the polarizing plate 7 onto the insulating substrate 31 by rolling the polarizing plate attaching roller 15, the liquid crystal material can flow toward the liquid crystal layer 5 in the pixel region not only from ends of two of the first recesses 39 extending along the respective long sides of the frame BM 32 that are located at a part of the liquid crystal layer 5 located opposite to a part thereof where the liquid crystal material locally gathers but also from the central parts of the respective two first recesses 39 through corresponding two of the second recesses 40, that is, through parts of the respective first recesses 39 located between the part thereof where the liquid crystal material locally gathers and the part thereof opposite to the part thereof where the liquid crystal material locally gathers. Thus, cell thickness can be further even out.

The first and second recesses 39 and 40 extend in a line symmetric manner with respect to a longitudinal center of the insulating substrate 31. In the above configuration, even if a start end and a termination end for attachment of the polarizing plate 7 are located at any side of the insulating substrate 31, that is, even if the polarizing plate attaching roller 15 is rolled in the longitudinal direction or the short direction of the bonded substrate, the same advantages can be obtained.

### Fourth Embodiment

FIG. 10 is a schematic plan view illustrating the bonded substrate of the counter substrate 3 and the TFT substrate 2 according to a fourth embodiment. Elements in the drawing that are the same as those in FIG. 8 are labelled using the same reference signs, and detailed description thereof is omitted.

In the fourth embodiment, the display apparatus includes a first recess 41 and second recesses 42. The first recess 41 extends in parallel to the periphery of the frame BM 32 along one of short sides of the frame BM 32 and continues to middle parts of the respective long sides thereof. The second recesses 42 and 42 are connected to respective ends of the first recess 41, extends perpendicularly thereto in plan view of an insulating substrate 31, and communicate with the liquid crystal layer 5 in the pixel region.

In the present embodiment, when the liquid crystal material locally gathers at a part of the liquid crystal layer 5 where attachment of the polarizing plate 7 terminates in attachment of the polarizing plate 7 onto the insulating substrate 31 by rolling the polarizing plate attaching roller 15, the liquid crystal material flows into the central part of the liquid crystal layer 5 in the longitudinal direction thereof through the first recess 41 and the second recesses 42. Thus, local gathering of the liquid crystal material can be released and the liquid crystal layer 5 can be further even out.

### Fifth Embodiment

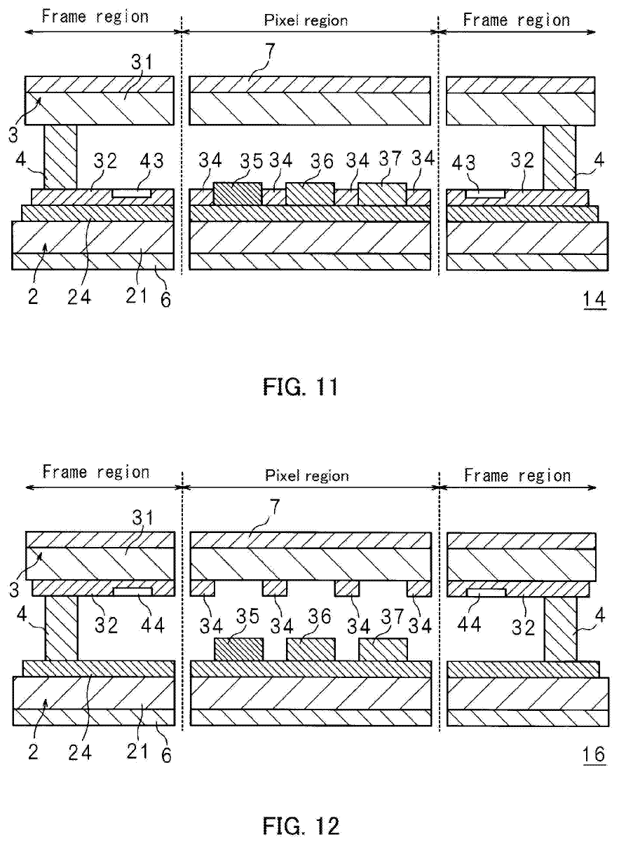

FIG. 11 is a schematic cross sectional view of a display panel 14 according to a fifth embodiment as viewed in a longitudinal direction thereof. Elements in the drawing that are the same as those in FIG. 7 are labelled using the same reference signs. The display panel 14 is in structure of color filter on array (COA) in which CFs are provided on or near a TFT substrate 2 as well as a frame BM 32 and a pixel BM 34.

The display panel 14 includes the TFT substrate 2, a counter substrate 3, a liquid crystal layer 5, a sealant 4, and polarizing plates 6 and 7. The TFT substrate 2 and the counter substrate 3 are opposite to each other. The liquid crystal layer 5 is located between the TFT substrate 2 and the counter substrate 3. The sealant 4 has a frame shape in which the liquid crystal layer 5 is sealed in between the TFT substrate 2 and the counter substrate 3. The polarizing plates 6 and 7 are disposed on respective outer surfaces of the TFT substrate 2 and the counter substrate 3.

In the display panel 14, a counter electrode (not illustrated) is provided on an insulating substrate 31 of the counter substrate 3 and an alignment film (not illustrated) covers the counter electrode.

An array layer 24 is provided on an insulating substrate 21 of the TFT substrate 2 of the display panel 14. The array layer 24 includes a plurality of signal lines arranged in parallel in the row direction, a plurality of gate lines arranged in parallel in the column direction, a plurality of TFTs disposed at respective intersections of the signal lines and the gate lines, and the like.

A pixel BM 34 is provided on the array layer 24 in the pixel region in a latticed manner to define red CFs 35, green CFs 36, and blue CFs 37. Respective pixel electrodes (not illustrated) are provided to cover the red CFs 35, the green CFs 36, and the blue CFs 37, and an alignment film (not illustrated) is provided to cover the pixel electrodes.

A rectangular frame BM 32 is provided on the array layer 24 in the fame region.

In the display panel 14, a recess 43 in a recessed groove shape extends around the entire periphery of the frame BM 32 in a part of the frame BM 32 located inwardly near the pixel region of the liquid crystal layer 5.

In also the display panel 14 in the fifth embodiment, when internal pressure of the liquid crystal layer 5 increases by local gathering of the liquid crystal material at a part of the liquid crystal layer 5 where attachment of the polarizing plate 7 terminates in a situation in which the polarizing plate 7 is attached onto the insulating substrate 31 by rolling the polarizing plate attaching roller 15, the liquid crystal material flows into the recess 43 and moves toward a part of the liquid crystal layer 5 located opposite to the part thereof where attachment of the polarizing plate 7 terminates in a similar manner to that in the display panel 1. Thus, local gathering of the liquid crystal material can be released.

### Sixth Embodiment

FIG. 12 is a schematic cross sectional view of a display panel 16 according to a sixth embodiment as viewed in a longitudinal direction thereof. Elements in the drawing that are the same as those in FIG. 11 are labelled using the same reference signs. The display panel 16 is in structure of color filter on array (COA) in which CFs are provided on or near a TFT substrate 2 while a frame BM 32 and a pixel BM 34 are provided on or near a counter substrate 3.

The display panel 16 includes the TFT substrate 2, the counter substrate 3, a liquid crystal layer 5, a sealant 4, and polarizing plates 6 and 7. The TFT substrate 2 and the counter substrate 3 are opposite to each other. The liquid crystal layer 5 is located between the TFT substrate 2 and the counter substrate 3. The sealant 4 has a frame shape in which the liquid crystal layer 5 is sealed in between the TFT substrate 2 and the counter substrate 3. The polarizing plates 6 and 7 are disposed on respective outer surfaces of the TFT substrate 2 and the counter substrate 3.

An array layer 24 is provided on an insulating substrate 21 of the TFT substrate 2 of the display panel 16. The array layer 24 includes a plurality of signal lines arranged in parallel in the row direction, a plurality of gate lines arranged in parallel in the column direction, a plurality of TFTs disposed at respective intersections of the signal lines and the gate lines, and the like.

Red CFs 35, green CFs 36, and blue CFs 37 are provided on the array layer 24 in the pixel region. Respective pixel electrodes (not illustrated) are provided to cover the red CFs 35, the green CFs 36, and the blue CFs 37, and an alignment film (not illustrated) is provided to cover the pixel electrodes.

The pixel BM 34 in a lattice shape is provided in correspondence with the respective CFs on an insulating substrate 31 of the counter substrate 3 of the display panel 16 in the pixel region to define the respective CFs.

The rectangular frame-shaped frame BM 32 is disposed on the insulating substrate 31 in the frame region.

In the display panel 16, a recess 44 in a recessed groove shape extends around the entire periphery of the frame BM 32 in a part of the frame BM 32 located inwardly near the pixel region of the liquid crystal layer 5.

In the display panel 16 according to the sixth embodiment, when internal pressure of the liquid crystal layer 5 increases by local gathering of the liquid crystal material at a part of the liquid crystal layer 5 where attachment of the polarizing plate 7 terminates in a situation in which the polarizing plate 7 is attached onto the insulating substrate 31 by rolling the polarizing plate attaching roller 15, the liquid crystal material flows into the recess 44 and moves toward a part of the liquid crystal layer 5 located opposite to a part of the liquid crystal layer 5 where attachment of the polarizing plate 7 terminates. Thus, local gathering of the liquid crystal material can be released.

It should be noted that the embodiment of the present invention is not limited to the above-described first to sixth embodiments and various alterations may be made without departing from the scope of claims. That is, any embodiments achieved by combining technical means appropriately altered within the scope of the claims are within the technical scope of the present invention.

### REFERENCE SINGS LIST

1, 13, 14, 16 Display panel
2 TFT substrate
21 Insulating substrate
22 Pixel electrode
23 Signal line
24 Array layer
3 Counter substrate
31 Insulating substrate
32 Frame BM (light shielding film)
33, 38, 43, 44 Recess
34 Pixel BM
35 Red CF
36 Green CF
37 Blue CF
39, 41 First recess
40, 42 Second recess
4 Sealant
5 Liquid crystal layer
7 Display module
8 Front cabinet
9 Rear cabinet
10 Tuner
11 Decoder
12 Stand
15 Polarizing plate attaching roller
100 TV receiver

1.-6. (canceled)

7. A liquid crystal display apparatus comprising:
two substrates;
a sealant that bonds the two substrates together;
a liquid crystal layer located between the two substrates and surrounded by the sealant;
a light shielding film in a frame shape disposed on a surface of one substrate of the two substrates, the surface facing the light shielding layer;
a first recess linearly extending along at least a part of a peripheral of the light shielding film in the light shielding film; and
a second recess extending in the light shielding film to be connected to the first recess and the liquid crystal layer in a pixel region.

8. The liquid crystal display apparatus according to claim 7, wherein
the light shielding film has a long side and a short side, the long side being connected to the short side with a corner,
the first recess includes a part located at at least a part of the short side and a part located at at least a part of the long side.

9. The liquid crystal display apparatus according to claim 7, wherein
the first recess extends around an entire periphery of the light shielding film.

10. The liquid crystal display apparatus according to claim 7, wherein
the one substrate is a counter substrate including a counter electrode, and
the light shielding film is a black matrix provided on the counter substrate in a frame region.

11. The liquid crystal display apparatus according to claim 7, wherein
the one substrate is a thin film transistor substrate, and
the light shielding film is a black matrix provided on the thin film transistor substrate in a frame region.

12. The liquid crystal display apparatus according to claim 7, wherein
the light shielding film has a first part and a second part larger in thickness than the first part,
the first recess is located at the first part of the light shielding film.

13. The liquid crystal display apparatus according to claim 9, wherein
the light shielding film has a first part and a second part larger in thickness than the first part,
the first recess is located at the first part of the light shielding film.

14. The liquid crystal display apparatus according to claim 10, wherein
the light shielding film has a first part and a second part larger in thickness than the first part,
the first recess is located at the first part of the light shielding film.
